(19) United States
(12) Patent Application Publication
(10) Pub. No.: US 2026/0288420 A1
(43) Pub. Date: Sep. 24, 2026

(54) SYSTEM AND METHOD FOR GENERATING A SOFTWARE MODULE BASED ON DATA COLLECTED

(71) Applicant: Quantum Connections Training LLC, Dallas, TX (US)

(72) Inventor: Dennis Scott Holland, Dallas, TX (US)

(73) Assignee: Quantum Connections Training LLC, Dallas, TX (US)

(21) Appl. No.: 19/083,512

(22) Filed: Mar. 19, 2025

(51) Int. Cl. G06F 8/30; G06Q 10/0639

(52) U.S. Cl. CPC G06F 8/30; G06Q 10/0639

(57) ABSTRACT

A method and system, performed by a computer system, for automatically generating a software module based on data collected from an employer computer system is described. The method comprises receiving, via the computer system over a communication network, net connected score (NCS) survey data from one or more employees via employee devices, performing predictive modelling on the NCS survey data to generate a measured value for each of one or more net connected score predictive drivers, computing, based on the measured values, a NCS for an employer, transmitting, from the one or more employees to the employer computer system, the measured values for the predictive drivers and the NCS, automatically analyzing the measured values for the predictive drivers using behavior modification data stored in a database to generate a customized training software module, and transmitting the training software module from the computer system to the employer computer system.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records but otherwise reserves all copyright rights whatsoever.

### BACKGROUND OF THE INVENTION

### Field of the Invention

This application generally relates to the field of data collection and analysis, and more specifically, but not exclusively to computer-implemented systems and methods for collecting and analyzing data and automatically generating a software module based on the data collected.

### Description of the Related Art

Generating a software module based on data collection and analysis is complex and challenging to manage. For instance, when large quantities of difficult to quantify data are collected, analyzing the data and generating a software module based on the data in an efficient, accurate, and timely manner becomes more technically challenging.

The current solutions are insufficient when it comes to generating a software module based on data collected. Therefore, there is a need in the art for improved methods and systems for efficiently managing data collection and analysis and generating a software module based on data collection.

### SUMMARY OF THE INVENTION

The present invention provides a system and method for automatically generating a software module based on data collected from an employer computer system. According to one embodiment, the method is performed by a computer system comprising one or more processor and memory devices. The method comprises receiving, via the computer system over a communication network, net connected score survey data from one or more employees using one or more employee devices. The method also comprises performing predictive modelling on the net connected score survey data to generate a measured value for each of one or more net connected score predictive drivers.

The method further comprises computing, based on the measured values for each of the one or more net connected score predictive drivers, a net connected score for an employer. The net connected score represents an employee perceived employee supervisor relationship. The method further comprises transmitting, from the one or more employees via the computer system to the employer computer system over the communication network, the measured values for each of the one or more net connected score predictive drivers and the net connected score.

The method further comprises automatically analyzing the measured values of the net connected score predictive drivers using behavior modification data stored in a database to generate a customized training software module. The customized training software module includes targeted training sessions based on which of the measured values of the net connected score predictive drivers are below a threshold value. The generated customized training software module is transmitted, via the communication network, from the computer system to the employer computer system.

In certain embodiments, the method can further comprise performing predictive modelling on the net connected score to generate an analysis of a relationship between the net connected score and at least one of employee retention, engagement, and profitability per employee in a given company. A higher net connected score can correlate to higher rates of employee retention, engagement, and profitability per employee. The measured value of the one or more net connected score predictive drivers can also correlate to employee retention, engagement, and profitability per employee.

In certain other embodiments, the net connected score survey data can comprise a single question answered by the one or more employees to provide insight into the employee perceived employee supervisor relationships within a company. The method can further comprise computing, via the computer system based on the net connected score survey data, a percentage of the one or more employees classified as connected, a percentage of the one or more employees classified as disconnected, and a percentage of the one or more employees classified as passive.

The percentage of employees classified as connected can be calculated by the following equation:

$$( \frac{Ec}{Et} ) \times 100 \%$$

Wherein Ec represents the number of employees of a company having a net connected score in a connected range and Et represents the number of total employees in the company.

The percentage of employees classified as disconnected can be calculated by the following equation:

$$( \frac{Ed}{Et} ) \times 100 \%$$

Wherein Ed represents the number of employees of a company having a net connected score in a disconnected range and Et represents the number of total employees in the company.

The percentage of employees classified as passive can be calculated by the following equation:

$$( \frac{Ep}{Et} ) \times 100 \%$$

Wherein Ep represents the number of employees of a company having a net connected score in a passive range and Et represents the number of total employees in the company.

Computing the net connected score of the employer can be performed by calculating the difference between the percentage of connected employees and the percentage of disconnected employees.

In some embodiments, the one or more net connected score predictive drivers can comprise at least one of employee perception of psychological safety, empowerment, appreciation, anxiousness, and boredom levels in the workplace. The method can further comprise analyzing, by the computer system, the employee perception of appreciation based on data obtained from the net connected score survey data. The perception of appreciation data can comprise employee perceived recognition of individual value and contributions data, employee perceived acknowledgement of unique skills and perspectives data, and employee perceived meaningful feedback from supervisor data.

The method can further comprise analyzing, by the computer system, the employee perceived empowerment based on data obtained from the net connected score survey data. The perception of empowerment data can comprise employee perceived authority to make decisions data, employee perceived support for taking initiative data, and employee perceived voice in team organizational matters data. The method further comprises analyzing, by the computer system, the employee perceived psychological safety based on data obtained from the net connected score survey data. The perception of psychological safety data can comprise employee perceived safety to express opinions data, employee perceived comfort in raising concerns data, and employee perceived trust in supervisor support data.

In some embodiments, the method can further comprise transmitting, by the generated training software module, a customized training session. The customized training session can comprise coaching supervisors on employee affirmation techniques, based on a measured value for employee perception of appreciation below a threshold value. The customized training session can also comprise coaching supervisors to focus on attentive listening skills and providing feedback to employees through dialogue, based on a measured value for employee perception of empowerment below a threshold value. Alternatively, the customized training session can include coaching supervisors to encourage open dialogue, model vulnerability, and foster a culture where mistakes are a learning opportunity, based on a measured value for employee perception of psychological safety below a threshold value.

The present invention provides a non-transitory computer readable media comprising computer program code that when executed by a programmable processor causes execution of a method performed by a computer system for automatically generating a software module based on data collected from an employer computer system. The non-transitory computer readable media comprises computer program code for receiving, via the computer system over a communication network, net connected score survey data from one or more employees using one or more employee devices. The non-transitory computer readable media also comprises computer program code for performing predictive modelling on the net connected score survey data to generate a measured value for each of one or more net connected score predictive drivers. The non-transitory computer readable media also comprises computer program code for computing a net connected score for an employer based on the measured values for each of the one or more net connected score predictive drivers. The net connected score represents an employee perceived employee supervisor relationship.

The non-transitory computer readable media further comprises computer program code for transmitting, from the one or more employees, via the computer system, to the employer computer system over the communication network, the measured values for each of the one or more net connected score predictive drivers and the net connected score. The non-transitory computer readable media also comprises computer program code for automatically analyzing the measured values of the net connected score predictive drivers using behavior modification data stored in a database to generate a customized training software module. The customized training software module comprises targeted training sessions based on which of the measured values of the net connected score predictive drivers are below a threshold value. The non-transitory computer readable media comprises computer program code for transmitting, via the communication network, the generated customized training software module from the computer system to the employer computer system.

In some embodiments, the non-transitory computer readable media can further comprise computer program code for performing predictive modelling on the net connected score to generate an analysis of an effect of the net connected score on employee retention, engagement, and profitability per employee for a given company. The non-transitory computer readable media can further comprise computer program code for computing, via the computer system, based on the net connected score survey data, a percentage of the one or more employees classified as connected, a percentage of the one or more employees classified as disconnected, and a percentage of the one or more employees classified as passive. Computing the net connected score can be performed by calculating the difference between the percentage of connected employees and the percentage of disconnected employees.

In certain other embodiments, the one or more net connected score predictive drivers include at least one of employee perception of psychological safety, empowerment, appreciation, anxiousness, and boredom levels in the workplace. The non-transitory computer readable media can further comprise computer program code for analyzing, by the computer system, the employee perception of appreciation based on the net connected score survey data. The perception of appreciation data can comprise employee perceived recognition of individual value and contributions data, employee perceived acknowledgement of unique skills and perspectives data, and employee perceived meaningful feedback from supervisor data.

The non-transitory computer-readable media can further comprise computer program code for analyzing, by the computer system, the employee perceived empowerment based on the net connected score survey data. The perception of empowerment data can comprise employee perceived authority to make decisions data, employee perceived support for taking initiative data, and employee perceived voice in team organizational matters data. The non-transitory computer-readable media can further comprise computer program code for analyzing, by the computer system, the employee perceived psychological safety based on the net connected score survey data, The perception of psychological safety data can comprise employee perceived safety to express opinions data, employee perceived comfort in raising concerns data, and employee perceived trust in supervisor support data.

In some embodiments, the non-transitory computer readable media can further comprise computer program code for transmitting, by the generated training software module, a customized training session. The customized training session can comprise coaching supervisors on employee affirmation techniques based on a measured value for employee perception of appreciation below a threshold value. The customized training session can also comprise coaching supervisors to focus on attentive listening skills and providing feedback to employees through dialogue based on a measured value for employee perception of empowerment below a threshold value. Alternatively, the customized training session can comprise coaching supervisors to encourage open dialogue, model vulnerability, and foster a culture where mistakes are a learning opportunity based on a measured value for employee perception of psychological safety below a threshold value.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 illustrates a flowchart of a method for generating a software module based on collected data according to an embodiment of the present invention;

FIG. 2 illustrates a system for generating a software module based on collected data according to an embodiment of the present invention;

FIG. 3 illustrates a computer system according to an embodiment of the present invention;

FIG. 4A illustrates a graph showing connected, disconnected, and passive results based on net connected score across multiple industries

FIG. 4B illustrates a graph showing statistics relating to the results of FIG. 4A based on net connected score across multiple industries;

FIG. 5 illustrates a generated software training module according to an embodiment of the present invention;

FIG. 6A illustrates a graph showing net connected score results by industry;

FIG. 6B illustrates a continuation of the graph of FIG. 6A;

FIG. 7A illustrates a diagram of the relationship between net connected score and profitability;

FIG. 7B illustrates a diagram of the relationship between net connected score and satisfaction;

FIG. 7C illustrates a diagram of the relationship between net connected score and tenure;

FIG. 7D illustrates a diagram of the relationship between net connected score and retention;

FIG. 7E illustrates a diagram of the relationship between net connected score and engagement;

FIG. 7F illustrates a diagram of the relationship between net connected score and productivity;

FIG. 8A illustrates a diagram of the relationship between net connected score and emotional appeal towards supervisors on an industry level;

FIG. 8B illustrates a diagram of the relationship between net connected score and emotional appeal towards company on an industry level; and

FIG. 9 illustrates a diagram of the relationship between net connected score and emotional appeal on an individual level.

FIG. 10 illustrates a diagram of the relationship between net connected score groups and predictive drivers.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized, and structural changes may be made without departing from the scope of the present invention. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

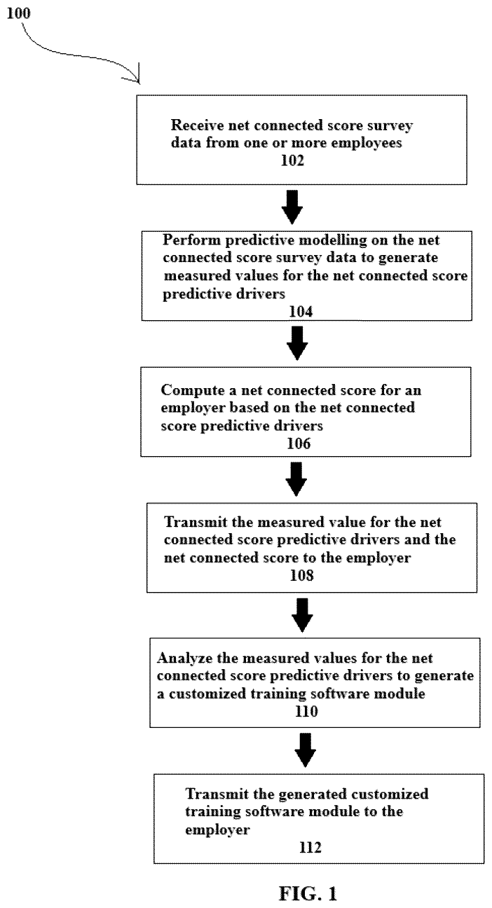

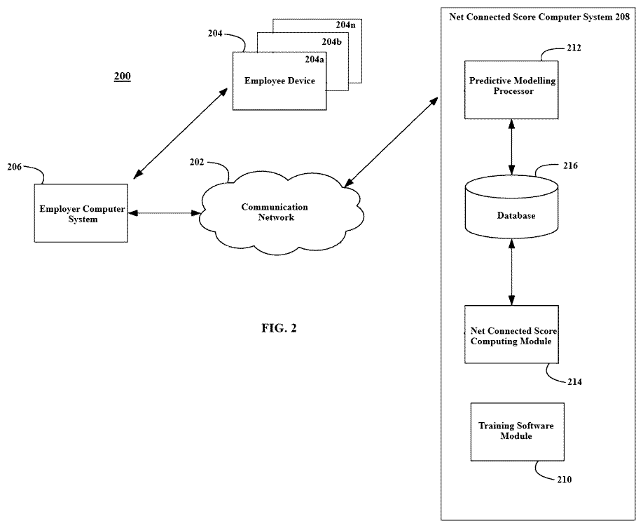

With reference to FIGS. 1 and 2, the present invention provides method 100 and system 200 for automatically generating a software module based on data collected from an employer computer system 206. The method 100 is performed by a computer system 208 comprising one or more processor and memory devices. The method 100 comprises receiving 102, via the computer system 208 over a communication network 202, net connected score survey data from one or more employees using one or more employee devices 204. Any number of employee devices can communicate with the system (e.g., 204a-204n). The method 100 also comprises performing 104 predictive modelling on the net connected score survey data to generate a measured value for each of one or more net connected score predictive drivers. The computer system 208 includes a predictive modelling processor 212 which generates the measured values for each of the net connected score predictive drivers.

The method 100 further comprises computing 106, based on the measured values for each of the one or more net connected score predictive drivers, a net connected score for an employer. The computer system 208 includes a net connected score module 214 which computes the net connected score. The net connected score can represent an employee perceived employee supervisor relationship. The net connected score can also measure an employee's feelings of connectedness within a company. The net connected score can quantify the impact of employee connection on business outcomes and provide actionable insights for leadership development and organizational improvement. The net connected score was developed from a study conducted by Sentient Insights across 12,000 employees in 49 industries, using rigorous multi-phase validation—including large-scale surveys, benchmarking, and predictive modeling—to deliver a powerful predictor of business performance that captures the essential human dynamic between employees and their immediate supervisors.

With continued reference to FIGS. 1 and 2, the method 100 further comprises transmitting 108, from the one or more employees (e.g., from the employee devices 204) via the computer system 208 to the employer computer system 206 over the communication network 202, the measured values for each of the one or more net connected score predictive drivers and the net connected score. As shown in FIG. 2, the computer system 208, includes the predictive modelling processor 212, the net connected score computing module 214, and a training software module 210. A database 216 is also included in or coupled to the computer system 208.

Employee devices 204 may comprise any computing devices (e.g., desktop computers, television devices, terminals, laptops, personal digital assistants (PDA), cellular phones, smartphones, tablet computers, e-book readers, smart watches and smart wearable devices, or any computing device having a central processing unit and memory unit capable of connecting to a network). Employee devices 204 1 may also comprise a graphical user interface (GUI) or a browser application provided on a display (e.g., monitor screen, LCD or LED display, projector, etc.).

The employee devices 204 may vary in terms of capabilities or features. For example, a web-enabled client device, which may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display. Employee devices 402 may also include or execute an application to communicate content, such as, for example, textual content, multimedia content, or the like. Employee devices 402 may include or execute a variety of operating systems, including a personal computer operating system, such as a Windows, Mac OS or Linux, or a mobile operating system, such as iOS, Android, or Windows Phone, or the like.

Communication Network 202 may be any suitable type of network allowing transport of data communications across thereof. The network 202 may couple devices so that communications may be exchanged, such as between servers and client devices or other types of devices, including between wireless devices coupled via a wireless network, for example. Network 202 may also include mass storage, such as network attached storage (NAS), a storage area network (SAN), cloud computing and storage, or other forms of computer or machine readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof.

Communications and content stored and/or transmitted to and from employee devices 204 may be encrypted using, for example, the Advanced Encryption Standard (AES) with a 128, 192, or 256-bit key size, or any other encryption standard known in the art.

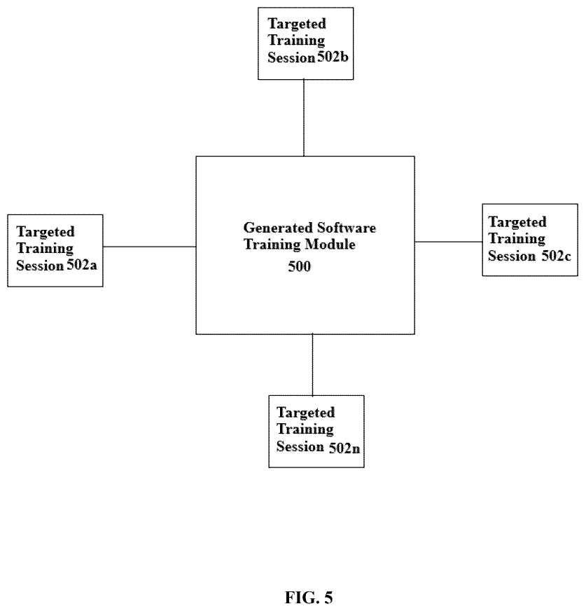

Referring back to FIG. 1, the method 100 further comprises automatically analyzing 110 the measured values of the net connected score predictive drivers using behavior modification data stored in a database 216 to generate a customized training software module 210. The customized training software module is described in further detail with reference to FIG. 5. The customized training software module 210 can facilitate improved employee connection within a company. The customized training software module 210 includes targeted training sessions based on which of the measured values of the net connected score predictive drivers are below a threshold value. The generated customized training software module 210 is transmitted, via the communication network 202, from the computer system 208 to the employer computer system 206.

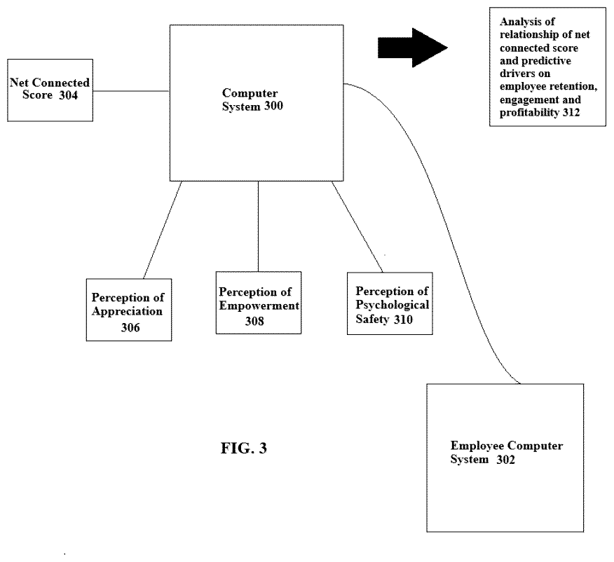

With reference to FIG. 3, in certain embodiments, the method can further comprise performing predictive modelling on the net connected score 304 to generate an analysis of a relationship between the net connected score and at least one of employee retention, engagement, and profitability per employee in a given company 312. A higher net connected score can correlate to higher rates of employee retention, engagement, and profitability per employee. The measured value of the one or more net connected score predictive drivers can also correlate to employee retention, engagement, and profitability per employee.

In some embodiments, the one or more net connected score predictive drivers can comprise at least one of employee perception of psychological safety 310, empowerment 308, and appreciation 306. Predictive drivers can also include anxiousness and boredom levels in the workplace. These five predictive drivers predict 69% of the variance in industry level net connected scores. When employees feel more empowered, appreciated, and safe, research shows the industry has a higher net connected score. When employees feel not bored, research shows the industry has a higher net connected score. When employees feel more anxious research shows the industry has a higher net connected score. Certain negative emotions, such as anxiety, can be powerful in creating connection and feeling seen and heard. Results surrounding industry level refer to results based on averages across the forty-nine industries part of Sentient Insight's research.

Further predictive drivers can include employee perception of feeling supported, inspired, excited, trusted, included, satisfied, not guarded, and not dejected by their supervisors. All of these predictive drivers impact whether or not a particular employee feels seen and heard by their direct supervisor and therefore impacts the net connected score. These predictive drivers are more predictive of net connected score at an individual level and predict the 22% variance in individual net connected score level. When employees feel more appreciated, empowered, safe, supported, inspired, excited, trusted, included, and satisfied, they feel more seen and heard by their supervisors. When employees feel not guarded, not bored, not dejected, and not anxious, they feel more seen and heard by their supervisors. Research has shown that anxiousness has different effects on the net connected score at the industry level versus the individual level. While at the industry level anxiety tends to foster connected between employees, at the individual level, employees feel less seen and heard when they are anxious. Results surrounding individual level refer to results based on averages across all individuals regardless of industry who were a part of Sentient Insight's study.

The computer system 300 can receive a net connected score (e.g., computed from net connected score computing module 214) and predictive driver data (e.g., from predictive modelling processor 212) and use this data to generate an analysis 312 of the relationship of the net connected score and predictive drivers on employee retention, engagement, and psychological safety.

In certain embodiments, the net connected score survey data can comprise a single question answered by the one or more employees to provide insight into the employee perceived employee supervisor relationships within a company. For example, the net connected score survey can ask employes, “On a scale of 1-10, how seen and heard do you feel by your direct supervisor?” Based on an employees' response to this question on a scale of 1-10, they can be classified as either connected, disconnected, or passive by the system.

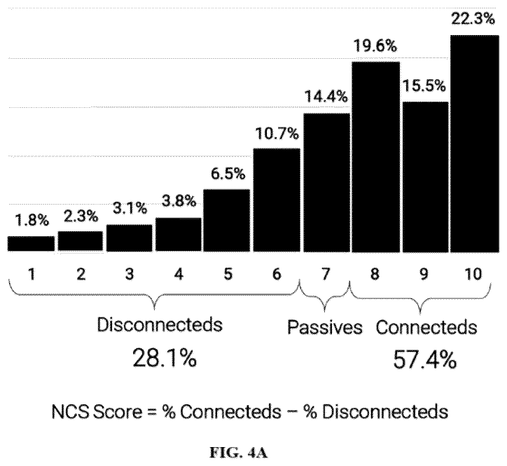

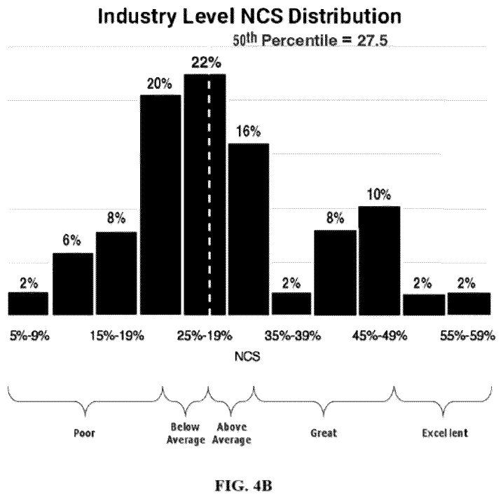

With reference to FIGS. 4A and 4B, the scoring on a scale of 1-10 is designed to create the greatest distinction between passive, connected, and disconnected employees when evaluating emotional appeal for a company and subconscious predictive drivers (e.g. psychological safety, empowerment, and appreciation) while also ensuring employees with similar profiles are scored in similar groups. For instance, those scoring between 1 and 6 can be classified as disconnected employees, those scoring a 7 can be classified as passive employees, and those scoring between 8 and 10 can be classified as connected employees. A number of employees scoring in each of the scoring ranges can be used to calculate the percentage of the total employees in a company that are connected, disconnected, and passive. FIG. 4A shows percentages of passive, connected, and disconnected employees at the industry level, and FIG. 4B dives deeper to show distribution of the net connected score at the industry level. For example, as shown in FIG. 4B, research from Sentient Insight has shown the average net connected score at the industry level is 29.3, the standard deviation is 11.7, minimum is 65 and maximum is 56.

The method can further comprise computing, via the computer system based on the net connected score survey data, a percentage of the one or more employees classified as connected, a percentage of the one or more employees classified as disconnected, and a percentage of the one or more employees classified as passive.

The percentage of employees classified as connected can be calculated by the following equation:

$$( \frac{Ec}{Et} ) \times 100 \%$$

Wherein Ec represents the number of employees of a company having a net connected score in a connected range and Et represents the number of total employees in the company.

The percentage of employees classified as disconnected can be calculated by the following equation:

$$( \frac{Ed}{Et} ) \times 100 \%$$

Wherein Ed represents the number of employees of a company having a net connected score in a disconnected range and Et represents the number of total employees in the company.

The percentage of employees classified as passive can be calculated by the following equation:

$$( \frac{Ep}{Et} ) \times 100 \%$$

Wherein Ep represents the number of employees of a company having a net connected score in a passive range and Et represents the number of total employees in the company.

Computing the net connected score of the employer can be performed by calculating the difference between the percentage of connected employees and the percentage of disconnected employees. Based on research conducted by Sentient Insights, the average net connected score at the industry level was found to be 29.3%. Out of the forty-nine industries that were part of the research, twenty-two of them were found to have a net connected score above the average.

In some embodiments, the net connected score survey data can include a series of questions used to determine a measured value for each of the net connected score predictive drivers. In this scenario, various feelings in the workplace can be measured through a series of specific questions. For instance, the system can measure feelings of appreciation, empowerment, psychological safety, boredom, and anxiousness, among other predictive drivers to provide insight to employers on areas where their management style can be improved to foster a more profitable work environment. The system quantifies the impact of workplace connection to facilitate improved business outcomes by focusing on improving management techniques.

With reference to FIG. 5, the method can further comprise analyzing, by the computer system, various predictive drivers (e.g. appreciation, empowerment, and psychological safety) and using the data to generate a software training module 500. The generated software training module 500 can access this predictive driver data and use it to create targeted training sessions 502a-502n that pertain specifically to each of the predictive drivers.

In one example, the employee perception of appreciation based on data obtained from the net connected score survey data can be quantified as a measured value. Data having an impact on feelings of employee appreciation, such as employee perceived recognition of individual value and contributions data, employee perceived acknowledgement of unique skills and perspectives data, and employee perceived meaningful feedback from supervisor data can be analyzed to determine the measured value. Based on whether the measured value is above or below a threshold, the software training module 500 can provide a targeted training session for the employer. If the measured value of perceived appreciation is below a certain threshold, the customized training session can comprise training techniques to improve sentiments of appreciation such as coaching supervisors on employee affirmation techniques. Training sessions are designed to create safe conversations between employees and supervisors by allowing supervisors to practice better management techniques to minimize negativity in the workplace and increase awareness by fostering structure dialogue between employees and supervisors.

In another example, the employee perception of empowerment based on data obtained from the net connected score survey data can be quantified as a measured value. Data having an impact on feelings of employee empowerment, such as perceived authority to make decisions data, employee perceived support for taking initiative data, and employee perceived voice in team organizational matters data can be analyzed to determine the measured value. Based on whether the measured value is above or below a threshold, the software training module 500 can provide a targeted training session for the employer. If the measured value of perceived empowerment is below a certain threshold, the customized training session can comprise training techniques to improve sentiments of empowerment such as coaching supervisors to focus on attentive listening skills and providing feedback to employees through dialogue.

In yet another example, the employee perception of psychological safety based on data obtained from the connected score survey data can be quantified as a measured value. Data having an impact on feelings of employee psychological safety, such as employee perceived safety to express opinions data, employee perceived comfort in raising concerns data, and employee perceived trust in supervisor support data can be analyzed to determine the measured value. Based on whether the measured value is above or below a threshold, the software training module 500 can provide a targeted training session for the employer. If the measured value of perceived psychological safety is below a certain threshold, the customized training session can comprise training techniques to improve sentiments of psychological safety such as coaching supervisors to encourage open dialogue, model vulnerability, and foster a culture where mistakes are a learning opportunity. The three most influential predictive drivers of employee connectedness at the industry level include feeling appreciated which has 28% impact on net connected score, feeling safe, which has a 33% impact on net connected score, and feeling empowered which has a 33% impact on net connected score.

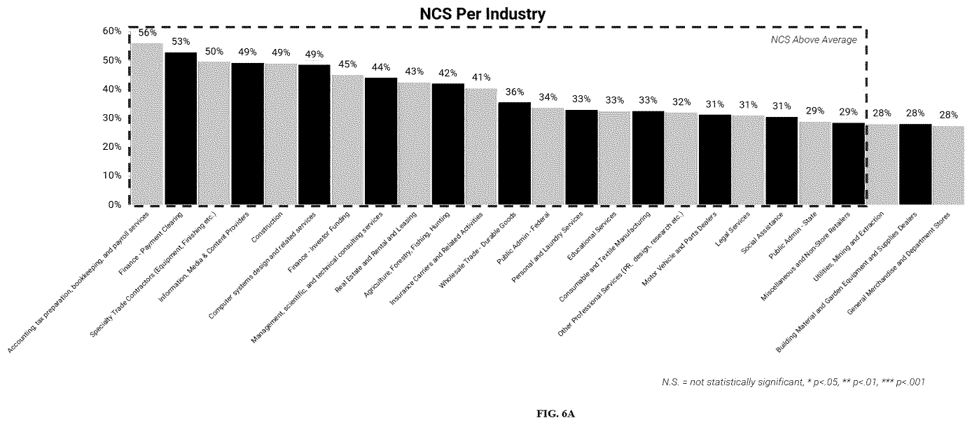

With reference to FIGS. 6A and 6B, exemplary average net connected scores by industry based on a study conducted by Sentient Insights are shown. Employers using the system and method as described herein to calculate a net connected score can use this exemplary data to compare their net connected score to the average net connected scores associated with their particular industry. A net connected score below average can indicate to employer a need to improve their management techniques (e.g., through the customized training sessions generated by the software training module).

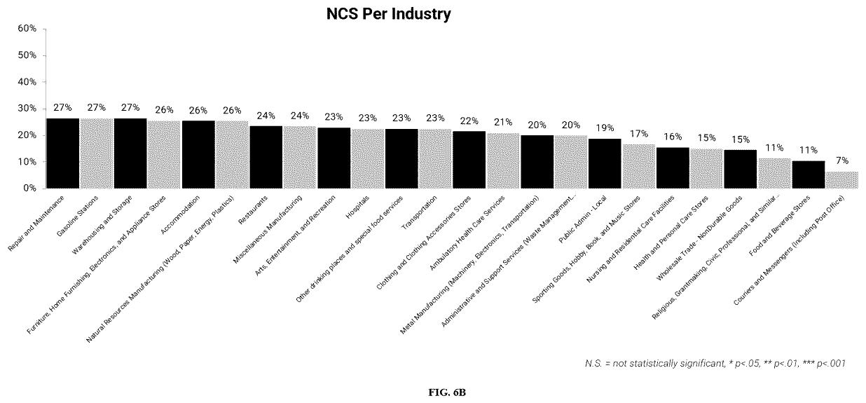

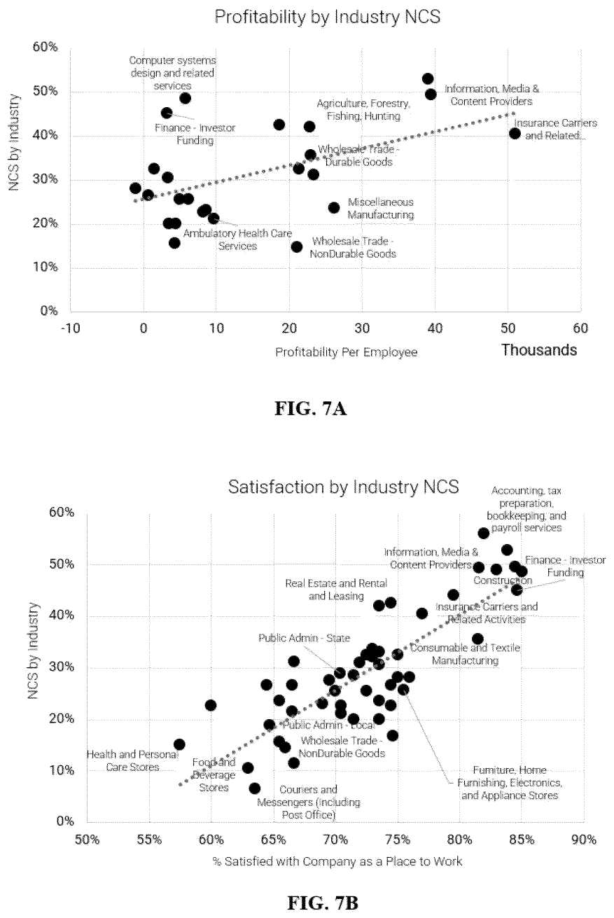

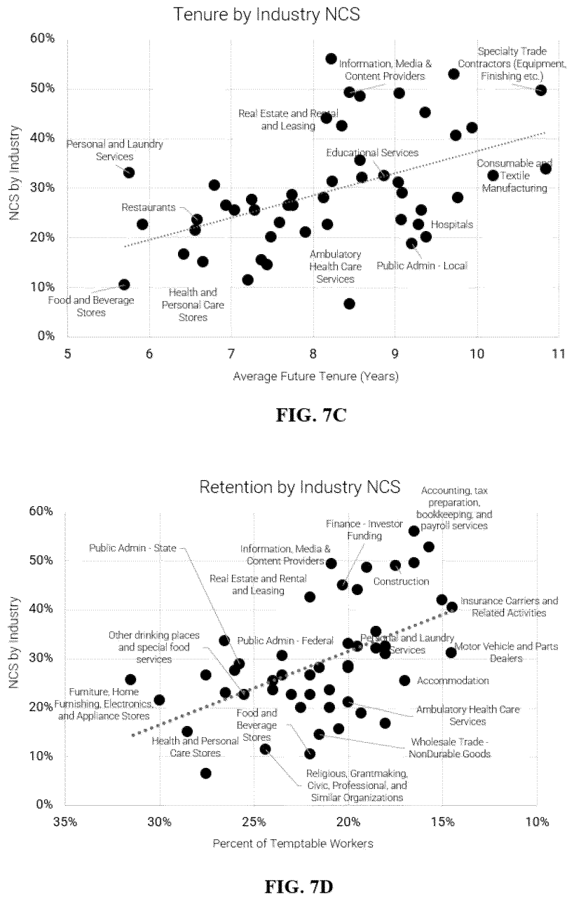

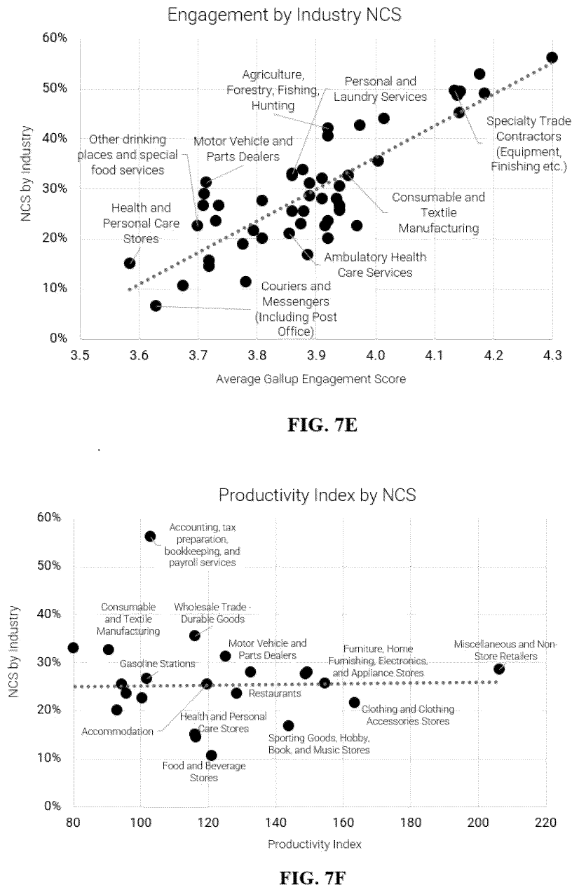

With reference to FIGS. 7A-7F, the effect of the net connected score on various business metrics is shown based on the study carried out by Sentient Insights. As shown in FIGS. 7A, 7B, 7C, 7D, and 7E, all of profitability, satisfaction, tenure, retention, and engagement are correlated to the calculated net connected score. As shown in FIG. 7F, productivity is not correlated to the calculated net connected score. Based on this information, employers can use the targeted training sessions to improve their net connected score and improve business metrics.

Referring to FIG. 7A, predictive modelling and statistical analysis research showed for every one-point increase in net connected score, the predicted profit per employee increases by $626 USD. Referring to FIG. 7B, predictive modelling and statistical analysis research showed industry level net connected score significantly predicts the proportion of people satisfied with their jobs. For every one-point increase in industry net connected score, 0.5% (+5/1000) more people are satisfied with their company. Individual level net connected score also showed a significant relationship to satisfaction. For every one-point increase in individual net connected score, people are 27% (0.27×) less likely to say they are open to new opportunities and are 89% more likely to say they are satisfied with their company.

Referring to FIG. 7C, predictive modelling and statistical analysis research showed industry level net connected scores are significantly predictive of how much time workers plan to be at their current employer. For every one-point increase in industry net connected score, 0.3% (+3/1000) more employees are likely to stay at least five years. For every one-point increase in industry net connected score, the average employee is likely to stay an additional nineteen days. Individual level net connected score responses are significantly related to intended future tenure (e.g., the amount of additional time an employee intends to stay at their current employer) as well. For every one-point increase in net connected score, an employee is predicted to stay an extra nine and a half months.

Referring to FIG. 7D, predictive modelling and statistical analysis research predicts the percent of temptable workers (e.g., people who would leave current job for equal but not lower offer) at the industry level and the percent of people who in the past six months have thought about leaving their employer at all, once a week, or more. At the individual level, net connect score predicts retention. For every one-point increase in net connected score, 19% (0.2×) of individuals are less likely to take same but not lower offer and 31% (0.3×) of individuals are less likely to think about leaving employer once a week or more.

Referring to FIG. 7E, predictive modelling and statistical analysis research showed industry level net connected score predicts 70% of the variance in average industry engagement scores. At the individual level, engagement scores are significantly different between disconnected, passive, and connected employees. Referring to FIG. 7F, the net connected score was not predictive of productivity.

The present invention provides a non-transitory computer readable media comprising computer program code that when executed by a programmable processor causes execution of a method performed by a computer system for automatically generating a software module based on data collected from an employer computer system. The non-transitory computer readable media comprises computer program code for receiving, via the computer system over a communication network, net connected score survey data from one or more employees using one or more employee devices. The non-transitory computer readable media also comprises computer program code for performing predictive modelling on the net connected score survey data to generate a measured value for each of one or more net connected score predictive drivers. The non-transitory computer readable media also comprises computer program code for computing a net connected score for an employer based on the measured values for each of the one or more net connected score predictive drivers. The net connected score represents an employee perceived employee supervisor relationship.

The non-transitory computer readable media further comprises computer program code for transmitting, from the one or more employees via the computer system to the employer computer system over the communication network, the measured values for each of the one or more net connected score predictive drivers and the net connected score. The non-transitory computer readable media also comprises computer program code for automatically analyzing the measured values of the net connected score predictive drivers using behavior modification data stored in a database to generate a customized training software module. The customized training software module comprises targeted training sessions based on which of the measured values of the net connected score predictive drivers are below a threshold value. The non-transitory computer readable media comprises computer program code for transmitting, via the communication network, the generated customized training software module from the computer system to the employer computer system.

In some embodiments, the non-transitory computer readable media can further comprise computer program code for performing predictive modelling on the net connected score to generate an analysis of an effect of the net connected score on employee retention, engagement, and profitability per employee for a given company. The non-transitory computer readable media can further comprise computer program code for computing, via the computer system, based on the net connected score survey data, a percentage of the one or more employees classified as connected, a percentage of the one or more employees classified as disconnected, and a percentage of the one or more employees classified as passive. Computing the net connected score can be performed by calculating the difference between the percentage of connected employees and the percentage of disconnected employees.

In certain other embodiments, the one or more net connected score predictive drivers include at least one of employee perception of psychological safety, empowerment, appreciation, anxiousness, and boredom levels in the workplace. The non-transitory computer readable media can further comprise computer program code for analyzing, by the computer system, the employee perception of appreciation based on the net connected score survey data. The data can comprise employee perceived recognition of individual value and contributions data, employee perceived acknowledgement of unique skills and perspectives data, and employee perceived meaningful feedback from supervisor data.

The non-transitory computer readable media can further comprise computer program code for analyzing, by the computer system, the employee perceived empowerment based on the net connected score survey data. The data can comprise employee perceived authority to make decisions data, employee perceived support for taking initiative data, and employee perceived voice in team organizational matters data. The non-transitory computer-readable media can further comprise computer program code for analyzing, by the computer system, the employee perceived psychological safety based on the net connected score survey data, The data can comprise employee perceived safety to express opinions data, employee perceived comfort in raising concerns data, and employee perceived trust in supervisor support data.

In some embodiments, the non-transitory computer readable media can further comprise computer program code for transmitting, by the generated training software module, a training session. When a low score for a particular predictive driver is detected, the generated software module can generate a training session tailored to improving skills shown to increase feelings associated with said predictive driver. For example, to improve sentiments relating to appreciation, training sessions can be focused on practicing affirmations and increasing overall awareness. The customized training session can comprise coaching supervisors on employee affirmation techniques based on a measured value for employee perception of appreciation below a threshold value.

To improve sentiments relating to empowerment, training sessions can be focused on engaging in structured conversation through mirroring, validating, and empathizing. The customized training session can also comprise coaching supervisors to focus on attentive listening skills and providing feedback to employees through dialogue based on a measured value for employee perception of empowerment below a threshold value. To improve sentiments of psychological safety, training sessions can be focused on minimizing negativity. Alternatively, the customized training session can comprise coaching supervisors to encourage open dialogue, model vulnerability, and foster a culture where mistakes are a learning opportunity based on a measured value for employee perception of psychological safety below a threshold value.

As the workplace continues to evolve, there is an increased need to foster connection in the workplace. With the rise of remote and hybrid working models, people working longer, resulting in up to five different generations in the workplace at a time, and growing diversity in the workforce, many companies struggle to maintain a sense of human connection in the workplace. Human connection in the workplace not only drives employees' wellbeing but also business performance. Studies carried out by Sentient Insight show that when employees feel seen and heard in the workplace by their direct supervisors (e.g., measured by the net connected score) individual and business outcomes improve.

A connected workforce has lower attrition rates, leading to years of additional employee tenure. Business performance follows, with increased profits per employee. Predictive drivers of increased employee retention and company profitability are rooted in deeper employee engagement. Work environments where employees feel connected foster a workforce that actively contributes to company success. When employees' feelings of being seen and heard increase, businesses experience increased engagement, retention, and profitability.

As a result of increased engagement, employees are at least 55% more likely to feel comfortable raising new ideas, 44% more likely to admit mistakes without fear of embarrassment, and 39% more likely to take calculated risks, 32% more likely to share ideas even if they are contradictory to others, and 40% more likely to ask “the hard questions” in front of others—all behaviors that drive innovation and team cohesion. As a result of increased retention, employees are at least 31% less likely to think about leaving their employer once a week and are likely to stay with the employer an additional nine and a half months, at a minimum—reducing the need for costly rehiring and retraining. As a result of increased profitability, fully connected workforces experience 38.7% greater profitability than fully disconnected workforces—fueling sustained business growth and stability.

In one real-world example, a Gen-Z employee had been working with a retail company for two years as an operations specialist. The employee was hired for their strong educational background and passion for the work. Recently, despite having numerous ideas for improving inventory management and customer service workflows, the employee has been hesitant to speak up during team meetings. The employee's supervisor was a Gen-X manager who had been at the company for over twenty years. The supervisor had a habit of quickly dismissing suggestions from the employee without discussion and had, on occasion, publicly criticized the employee for questioning an existing process. The employee often felt neither seen nor heard and noticed themselves withdrawing from voluntary projects and stopping their practice of documenting process improvement ideas, which they previously did regularly when first starting at the company.

In a recent inventory crisis at the company, that resulted in significant loss of sales, the employee had identified the systematic issues leading to the crisis months earlier but hadn't felt safe raising it to their supervisor. As the crisis unfolded, the employee felt frustration and resignation which ultimately led the employee to leave the company. In this example, the supervisor's management style not only suppressed insightful ideas from the employee but also drove the employee along with their talent and potential away. The systems and methods herein, if implemented by this company, would have been able to identify the feelings of the employee early on and provide a net connected score to the company. Based on that score and the data collected about the employee's feelings, a customized training module for behavior modification would have been provided to the supervisor making them aware of the flaws in their management style.

The above disclosed systems and methods provide a practical roadmap for companies seeking to build a more connected and productive workplace in today's complex environment. Through investing in fundamental human connections, particularly between supervisors and their teams, the global crisis of workplace detachment can be addressed, and the full potential of employees and companies can be unlocked. Change comes from transforming the fundamental way people are managed and connected at work. While the need for connection is universal, the path to achieving it must be thoughtfully tailored to each organization's unique context, which is why the systems and methods as described herein provide tailored training sessions to address each companies' individual needs based on the data collected and the net connected store calculated.

Unlike traditional engagement measures that focus broadly on organizational satisfaction, the net connected score focuses on whether employees feel seen and heard by their direct supervisors, an often overlooked but critical driver of key business outcomes. The degree to which employees feel seen and heard by their immediate supervisor is directly correlated to the key performance indicators of employee including engagement, retention, and profitability. Organizations that foster a culture of connection at work through psychological safety, strong supervisor relationships, and supportive team dynamics see measurable improvements in employee performance, collaboration, and decision-making-ultimately translating into stronger business outcomes.

The deficiencies of traditional methods of employee satisfaction metrics are evidenced by companies struggling to maintain engagement and retention in today's complex work environment. These traditional methods were designed for a different era of work, when the traditional in person work week was still the standard normal, workplace hierarchies were clearer, and technology played a less dominant role in workplace relationships. Traditional methods provide broad insights into overall workplace satisfaction but fail to capture the fundamental human dynamic that drives long-term success (e.g., the connection between employees and their direct supervisors). As a result, traditional methods are deficient in predicting long term retention, future/planned tenure, percent of temptable workers in the work force, and predictive drivers such as appreciation, empowerment, and psychological safety.

Engaged employees fuel innovation. Employees with high net connected scores are, at a minimum, 55% more likely to share new ideas, 44% more likely to admit mistakes without fear, and 39% more likely to take calculated risks. And employees in high net connected score environments are, at a minimum, 35% more likely to make innovation attempts and 32% more likely to suggest process improvements which are all key drivers of operational improvements and business growth.

Retention improves with connection. As employees' feelings of connection increase, they are, at a minimum, 31% less likely to think about leaving their employer once a week and are 19% less likely to take a job offer of equal pay. Employees within the most connected workforces report greater long-term retention intentions. Companies in the top 10% of net connected scores show an increase in two and a quarter years of long-term employment, on average, over companies in the bottom 10% of net connected scores.

Connection drives profitability. Fully connected workforces experienced 38.7% greater profitability than fully disconnected workforces. Even small improvements make a difference. For instance, for every one-point increase in net connected score, companies see a 4.3% boost in per-employee profitability.

The validation of the net connected score is evidenced by research carried out in multiple phases. Phase one included review of existing literature and scale identification to identify gaps in traditional engagement measurement. Phase two included an initial quantitative survey of 2,000 U.S. employees to refine the metric and validate its effectiveness. Phase three included a quantitative benchmarking study of 10,000 U.S. employees across forty-nine industries to assess consistency across workplace environments. Finally, phase four included predictive modelling of business outcomes and statistical analysis to measure the relationship between the net connected score and key business outcomes such as engagement, retention, and profitability.

For each quantitative survey phase, the research was conducted online among a representative population of U.S. workers. In phase two, the study focused on full-time employed workers. Phase three expanded the research to encapsulate both part-time and full-time workers. The survey length was an average of twenty minutes and included multiple batteries of explicit questions and implicit research technology measures ensuring highest quality data and eliminating any potential for survey fraud through automated bots.

The initial validation phase (e.g., Phase 2) established the fundamental psychometric properties of the net connected score through representative sampling and rigorous statistical analysis. With strong internal consistency (Cronbach's α=0.89), the measure demonstrated excellent reliability across different workplace contexts and employee groups. Importantly, discriminant validity testing showed that while the net connected score correlates with job satisfaction, it measures a distinct construct, providing unique insights beyond traditional satisfaction metrics.

Research showed the net connected score was related to existing industry measures such as the Gallup Engagement Scale, and Employee Net Promoter Score (eNPS). Yet importantly, the net connected score is distinct from existing industry measurement tools in important ways through its ability to capture inter-team dynamics. The net connected score proved to be uniquely related to Edmondson's Psychological Safety scale, a key finding that justified deeper drivers analyses in comparison to other existing metrics.

The next phase of research (Phase 3) significantly expanded both the sample size and the scope of the validation, providing more definitive evidence of the unique value of the net connected score. The improved internal consistency (Cronbach's α=0.91) reinforced the measure's reliability. Multi-level factor analysis across industries confirmed the measure's consistency across different business contexts. Net connected scores varied significantly across industries, revealing important insights for employers in different sectors. The variations demonstrated that while connection is universal, the challenges employers face in achieving will vary according to context. By providing a clear, measurable way to assess connection at work, the net connected score offers organizations a practical, research-backed tool to improve management practices and drive meaningful business outcomes.

Predictive modelling and statistical analysis research found that employees classified as connected by the net connected score results were 42% more likely to participate in team meetings, 38% more likely to share ideas in team meetings and 33% more to contribute to the quality of team meetings. Additionally connected employees were 45% more likely to take initiative in the workplace, 37% more likely to solve problems, and 41% more likely to collaborate and share ideas with others. Finally, research also showed that connected employees were 39% more likely to take calculated risks at work, 35% more likely to make innovative attempts, and 32% more likely to suggest process improvements. All these results evidence that connected employees are more engaged employees.

Predictive modelling and statistical analysis research also showed the strength of the relationship between an employee and supervisor is directly related to employee retention. First, the more employees feel seen and heard by their supervisor, the greater their implicit emotional appeal. These lifts in implicit associations mean that feeling seen and heard creates an automatic emotional bond for employees. Those emotional associations are the bond that provides rewards to the employee and ultimately to the business in tangible ways. Research conducted across forty-nine industries revealed a 22% reduction in voluntary turnover per ten net connected score points, at the industry level. In fact, each point increase in employee net connected score scale rating predicted nine and a half months of additional tenure.

Companies in the bottom 10% of net connected score have over 2× the amount of temptable employees within their workforce compared to companies in the top 10% of net connected score. Temptable workers think about leaving their company at least once a week and do not require an offer of higher compensation to leave their current employer. The net connected score provides an accurate predictor of temptable employees who have considered leaving their current positions in the past six months. Further, companies in the top 10% of connected workforces have employees with over two more years of intended tenure than companies in the bottom 10% of connected workforces.

Finally, predictive modelling and statistical analysis demonstrated the impact of net connected score starts with engagement, leads to retention, and ultimately delivers increased profitability for businesses. Profitability correlations showed a clear financial relationship. Fully connected workforces experienced 38.7% greater profitability than fully disconnected workforces. While that relationship shows the potential grand impact of transforming an organizational culture, gains in profitability can be achieved with even small increases in net connected score. Each net connected score point increase corresponds to a 4.3% profit increase per employee.

In environments where employee supervisor relationships can flourish, business results follow—but the path to creating these environments can vary dramatically by industry context. For example, financial services emerged as the highest-performing sector, with an average connected employee score of 56%. In an industry often stereotyped as impersonal, the best-performing organizations have made a human connection with their employees. Information, Media and Content Providers and Technology firms follow closely behind and these top industries, both in terms of profitability and in net connected score performance, share common characteristics in the supervisor/employee relationship dynamic. In these service industries, the mentor-mentee relationship is built into the business model and that may describe the observed strong business performance. Technology firms having a connected employee score of 49%, may succeed due to their embrace of flat hierarchies and open communication channels. In contrast, courier and messaging services having a connected employee score of only 7% reveal how structural barriers can impede human connection.

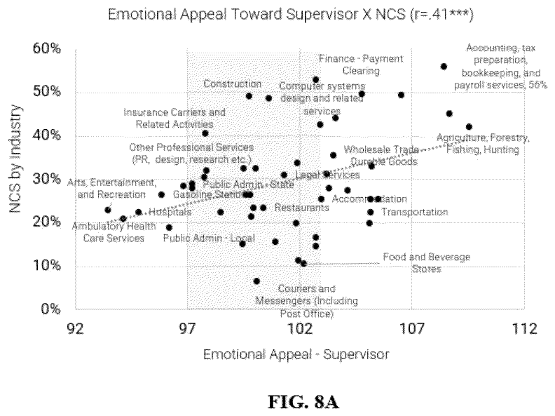

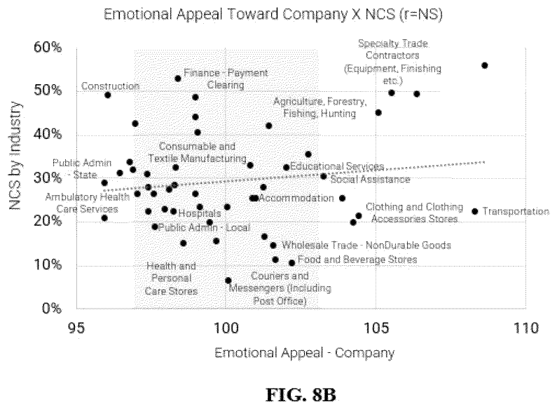

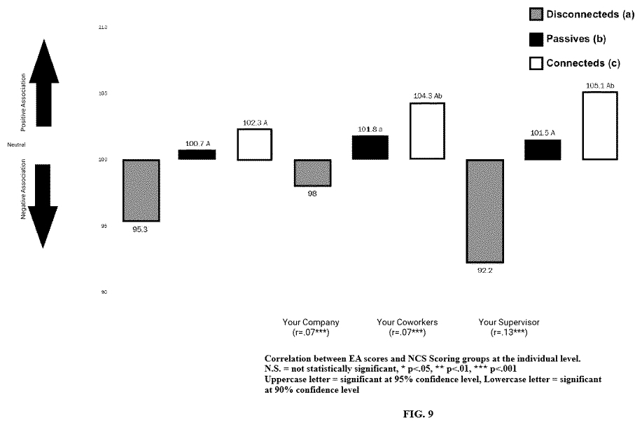

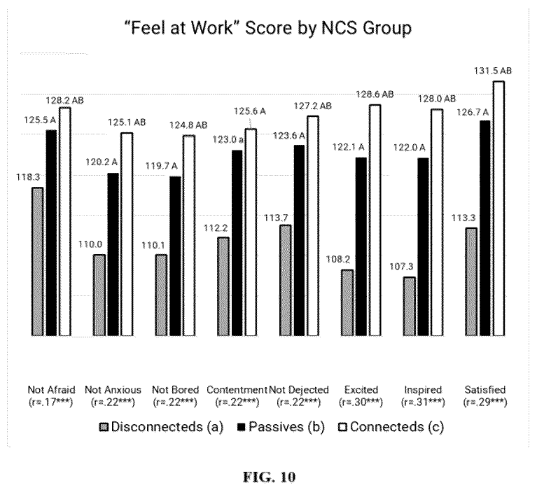

Through research conducted across multiple industries, the relationship between net connected score and emotional appeal towards a company was observed. With reference to FIGS. 8A and 8B, at the industry level, 63% of industries have a neutral or negative emotional appeal toward their company, 51% being negative emotional appeal toward their company and 12% being neutral emotional appeal towards their company. With reference to FIG. 9, at the individual level, the average implicit emotional appeal is neutral towards employers (100.1). Implicit emotional appeal toward supervisors (101.0) and coworkers (102.2) was marginally positive. This disconnect at the individual and industry level demonstrates a need for training focused on improving connections in the workplace. FIG. 10 shows the correlation between disconnected, passive, and connected employees and predictive drivers.

FIGS. 1 through 10 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A method, performed by a computer system comprising one or more processor and memory devices, of automatically generating a software module based on data collected from an employer computer system, the method comprising:
receiving, via the computer system over a communication network, net connected score survey data from one or more employees using one or more employee devices;
performing predictive modelling on the net connected score survey data to generate a measured value for each of one or more net connected score predictive drivers;
computing a net connected score for an employer based on the measured values for each of the one or more net connected score predictive drivers, the net connected score representing an employee perceived employee supervisor relationship;
transmitting, from the one or more employees via the computer system to the employer computer system over the communication network, the measured values for each of the one or more net connected score predictive drivers and the net connected score;
automatically analyzing the measured values of the net connected score predictive drivers using behavior modification data stored in a database to generate a customized training software module, the customized training software module comprising targeted training sessions based on which of the measured values of the net connected score predictive drivers are below a threshold value; and
transmitting, via the communication network, the generated customized training software module from the computer system to the employer computer system.

2. The method of claim 1, further comprising performing predictive modelling on the net connected score to generate an analysis of a relationship between the net connected score and at least one of employee retention, engagement, and profitability per employee in a given company.

3. The method of claim 2, wherein a higher net connected score correlates to higher
rates of employee retention, engagement, and profitability per employee.

4. The method of claim 2, wherein the measured value of the one or more net connected
score predictive drivers is directly correlated to employee retention, engagement, and profitability per employee.

5. The method of claim 1, wherein the net connected score survey data comprises a single question answered by the one or more employees to provide insight into the employee perceived employee supervisor relationships within a company.

6. The method of claim 1, further comprising computing, via the computer system based on the net connected score survey data, a percentage of the one or more employees classified as connected, a percentage of the one or more employees classified as disconnected, and a percentage of the one or more employees classified as passive.

7. The method of claim 6, wherein the percentage of employees classified as connected is calculated by the following equation:
$$( \frac{Ec}{Et} ) \times 100 \%$$

8. The method of claim 6, wherein the percentage of employees classified as disconnected is calculated the following equation:
$$( \frac{Ed}{Et} ) \times 100 \%$$

9. The method of claim 6, wherein the percentage of employees classified as passive is calculated by the following equation:
$$( \frac{Ep}{Et} ) \times 100 \%$$

10. The method of claim 6, wherein computing the net connected score of the employer is performed by calculating a difference between the percentage of connected employees and the percentage of disconnected employees.

11. The method of claim 1, wherein the one or more net connected score predictive drivers comprise at least one of employee perception of psychological safety, empowerment, appreciation, anxiousness, and boredom levels in the workplace.

12. The method of claim 11, further comprising analyzing, by the computer system, the employee perception of appreciation based on data obtained from the net connected score survey data comprising employee perceived recognition of individual value and contributions data, employee perceived acknowledgement of unique skills and perspectives data, and employee perceived meaningful feedback from supervisors data.

13. The method of claim 11, further comprising analyzing, by the computer system, the employee perceived empowerment based on data obtained from the net connected score survey data comprising employee perceived authority to make decisions data, employee perceived support for taking initiative data, and employee perceived voice in team organizational matters data.

14. The method of claim 11, further comprising analyzing, by the computer system, the employee perceived psychological safety based on data obtained from the net connected score survey data comprising employee perceived safety to express opinions data, employee perceived comfort in raising concerns data, and employee perceived trust in supervisor support data.

15. The method of claim 12, further comprising transmitting, by the generated training software module, a customized training session coaching supervisors on employee affirmation techniques, based on a measured value for employee perception of appreciation below a threshold value.

16. The method of claim 13, further comprising transmitting, by the generated training software module, a training session coaching supervisors to focus on attentive listening skills and providing feedback to employees through dialogue, based on a measured value for employee perception of empowerment below a threshold value.

17. The method of claim 14, further comprising transmitting, by the generated training software module, a training session coaching supervisors to encourage open dialogue, model vulnerability, and foster a culture where mistakes are a learning opportunity, based on a measured value for employee perception of psychological safety below a threshold value.

18. Non-transitory computer readable media comprising computer program code that when executed by a programmable processor causes execution of a method performed by a computer system for automatically generating a software module based on data collected from an employer computer system, the computer readable media comprising:
computer program code for receiving, via the computer system over a communication network, net connected score survey data from one or more employees using one or more employee devices;
computer program code for performing predictive modelling on the net connected score survey data to generate a measured value for each of one or more net connected score predictive drivers;
computer program code for computing a net connected score for an employer based on the measured values for each of the one or more net connected score predictive drivers, the net connected score representing an employee perceived employee supervisor relationship;
computer program code for transmitting from the one or more employees, via the computer system to the employer computer system over the communication network, the measured values for each of the one or more net connected score predictive drivers and the net connected score;
computer program code for automatically analyzing the measured values of the net connected score predictive drivers using behavior modification data stored in a database to generate a customized training software module, the customized training software module comprising targeted training sessions based on which of the measured values of the net connected score predictive drivers are below a threshold value; and
computer program code for transmitting, via the communication network, the generated customized training software module from the computer system to the employer computer system.

19. The non-transitory computer readable media of claim 18, further comprising computer program code for performing predictive modelling on the net connected score to generate an analysis of an effect of the net connected score on employee retention, engagement, and profitability per employee for a given company.

20. The non-transitory computer readable media of claim 18, further comprising computer program code for computing, via the computer system, based on the net connected score survey data, a percentage of the one or more employees classified as connected, a percentage of the one or more employees classified as disconnected, and a percentage of the one or more employees classified as passive.

21. The non-transitory computer readable media of claim 20, wherein computing the net connected score is performed by calculating a difference between the percentage of connected employees and the percentage of disconnected employees.

22. The non-transitory computer readable media of claim 18, wherein the one or more net connected score predictive drivers comprise at least one of employee perception of psychological safety, empowerment, appreciation, anxiousness, and boredom levels in the workplace.

23. The non-transitory computer readable media of claim 22, further comprising computer program code for analyzing, by the computer system, the employee perception of appreciation based on the net connected score survey data comprising employee perceived recognition of individual value and contributions data, employee perceived acknowledgement of unique skills and perspectives data, and employee perceived meaningful feedback from supervisor data.

24. The non-transitory computer readable media of claim 22, further comprising computer program code for analyzing, by the computer system, the employee perceived empowerment based on the net connected score survey data comprising employee perceived authority to make decisions data, employee perceived support for taking initiative data, and employee perceived voice in team organizational matters data.

25. The non-transitory computer readable media of claim 22, further comprising computer program code for analyzing, by the computer system, the employee perceived psychological safety based on the net connected score survey data comprising employee perceived safety to express opinions data, employee perceived comfort in raising concerns data, and employee perceived trust in supervisor support data.

26. The non-transitory computer readable media of claim 23, further comprising computer program code for transmitting, by the generated training software module, a training session coaching supervisors on employee affirmation techniques based on a measured value for employee perception of appreciation below a threshold value.

27. The non-transitory computer readable media of claim 24, further comprising computer program code for transmitting, by the generated training software module, a training session coaching supervisors to focus on attentive listening skills and providing feedback to employees through dialogue based on a measured value for employee perception of empowerment below a threshold value.

28. The non-transitory computer readable media of claim 25, further comprising computer program code for transmitting, by the generated training software module, a training session coaching supervisors to encourage open dialogue, model vulnerability, and foster a culture where mistakes are a learning opportunity based on a measured value for employee perception of psychological safety below a threshold value.
